(19) United States
(12) Patent Application Publication
(10) Pub. No.: US 2008/0294802 A1
(43) Pub. Date: Nov. 27, 2008

(54) Stream processing device and storage device

(76) Inventors: Nobuaki Kohinata, Yokohama (JP); Mika Mizutani, Tokyo (JP)

Correspondence Address: MCDERMOTT WILL & EMERY LLP, 600 13TH STREET, N.W., WASHINGTON, DC, 20005-3096, US

(21) Appl. No.: 12/078,810

(22) Filed: Apr. 4, 2008

(30) Foreign Application Priority Data
May 24, 2007 (JP) 2007-137360

(51) Int. Cl. G06F 13/14

(52) U.S. Cl. 710/6

(57) ABSTRACT

The invention provides a stream data control module which can easily achieve a function expansion of a digital device and can simply, safely and inexpensively realize the recording and reproducing of stream data for a storage device. A stream data control module includes a stream I/F unit exclusively inputting and outputting stream data, a non-stream I/F unit inputting and outputting non-stream data, a device I/F unit providing an interface to data storage means, and a control unit executing a transfer process of the stream data in response to a recording command and a reproducing command given from host means. The control unit has a stream arrangement management unit managing a storing position of the stream data in the data storage means, a scheduling unit controlling a transfer order of the stream data and the non-stream data, and a command processing unit interpreting various commands given from the host means.

### CROSS-REFERENCE TO RELATED APPLICATION

The present application claims priority from Japanese Patent Application No. JP 2007-137360 filed on May 24, 2007, the content of which is hereby incorporated by reference into this application.

### TECHNICAL FIELD OF THE INVENTION

The present invention relates to a stream data control module for recording and reproducing stream data such as image and music for storage devices such as a hard disk drive and a semiconductor flash memory. More particularly, it relates to a technique capable of simply, safely and inexpensively recording and reproducing the stream data.

### BACKGROUND OF THE INVENTION

A hard disk drive (HDD) serving as a peripheral device of a personal computer (PC) and used as a storage device for storing an operating system (OS), an application program, text data prepared by a user and the like has been employed as storage means of stream data such as image and voice in various consumer-oriented digital devices such as an HDD recorder, a set top box (STB) and a camcorder.

Further, as other storage devices, particularly in portable digital devices such as a cellular phone and a mobile player, a semiconductor flash memory which is excellent in an impact resistance and a low-power operation has come to be utilized because a mechanical structure like that in the HDD is not provided therein.

The configuration and operation of an HDD recorder 91 that is a digital device in which an application of the HDD has been rapidly developed will be described here with reference to FIG. 9. FIG. 9 is a configuration diagram showing the configuration of the conventional HDD recorder 91 that records and reproduces the stream data.

The HDD recorder 91 includes a digital tuner 22 constituting host means, a demultiplexer 23, a stream filter 24, an audio/video (A/V) decoder 25, a host central processing unit (CPU) 27, a memory 28, an advanced technology attachment (ATA) I/F 32, and an HDD 29 constituting data storage means.

The digital tuner 22, the demultiplexer 23, the stream filter 24, the A/V decoder 25, the host CPU 27, the memory 28, and the ATA I/F 32 are connected to each other via a general bus 26, and necessary commands and various data can be exchanged through the bus 26.

The host CPU 27 corresponds to a microprocessor that executes an OS for controlling and managing an input and output (I/O) operation with respect to an antenna, a display apparatus such as a plasma television, a speaker and the HDD 29 and a use resource of the memory 28, and executes application programs of a viewer, a graphical user interface (GUI) and the like. Also, the memory 28 is used as a work memory for the OS and the application programs and a buffer memory for the various data.

The stream filter 24 controls a flow of the stream data in accordance with the operations such as extraction of desired content from the stream data, watching of the contents in the HDD recorder 91 and recording and reproducing of the contents.

Incidentally, when the digital broadcasting contents received by the antenna are to be watched in the HDD recorder 91, the scramble of a transport stream (TS) output from the digital tuner 22 is canceled by the demultiplexer 23, and a target program content or service is next selected by the stream filter 24 and then transferred to the A/V decoder 25.

Thereafter, in the A/V decoder 25, the decoding is performed in accordance with an encoding method of the compressed digital data supplied as the TS, for example, the moving picture experts group (MPEG)-2, the MPEG-4, and the advanced audio coding (AAC), and the decoded data are output to the display apparatus and the speaker.

Also, when the received digital broadcasting contents are to be recorded, the host CPU 27 mainly buffers the TS output from the stream filter 24 temporarily in the memory 28 via the general bus 26.

Thereafter, when a predetermined amount of stream data is buffered, the stream data is read out from the memory 28 by the host CPU 27, and the stream date is stored in the HDD 29 via the ATA I/F 32 while sequentially determining recording positions in the HDD 29.

On the other hand, when the stored stream data is to be reproduced, the host CPU 27 mainly reads out desired stream data sequentially from the HDD 29 via the ATA I/F 32 and buffers the stream data in the memory 28. Thereafter, when a predetermined amount of stream data is buffered, the stream data is read out from the memory 28 by the host CPU 27 in conformity to a bit rate thereof, for example, 20 Mbps and then transferred to the A/V decoder 25 via the stream filter 24.

Alternatively, the reproduction can be performed by sequentially reading out the desired stream data from the HDD 29 via the ATA I/F 32 in conformity to the bit rate thereof, and transferring the stream data to the A/V decoder 25 from the stream filter 24 via the memory 28.

In the conventional HDD recorder 91 mentioned above, it is possible to reproduce the other stream data which has been already recorded while recording the stream data of the received content in the HDD 29, and also possible to simultaneously execute data processing not related to the stream data such as watching a photograph stored in the HDD 29 and updating program information while executing a process related to the stream data.

Further, with regard to the recording and reproducing of the stream date in an HDD such as the HDD recorder 91 mentioned above, a technique for optimizing a transfer rate is described in Japanese Patent Application Laid-Open Publication No. 2006-85243 (patent document 1).

However, although the transfer rate is optimized in the technique of the patent document 1, the stream data have to be securely recorded in the HDD 29 by using the general bus 26 whose frequency band is not ensured, and the stream data have to be read out from the HDD 29 in conformity to the bit rate and transferred to the A/V decoder 25. Therefore, it is necessary to execute an advanced I/O control in the host CPU 27. Accordingly, there is a problem that a processing load of the host CPU 27 is increased.

For the solution of the problem mentioned above, for example, Japanese Patent Application Laid-Open Publication No. 08-195031 (patent document 2) discloses a hard disk device. In this hard disk device, a data-only interface inputting and outputting data to be recorded/reproduced to and from the hard disk device and an interface inputting and outputting the commands and addresses other than the data are separately provided.

However, in the configuration described in the patent document 2, since it is impossible to simultaneously input and output the stream data and the other data, there occurs a problem that it is impossible to simultaneously perform the operations of recording the stream data to the hard disk device and reading the photograph data and writing the program information, and further impossible to simultaneously perform the operations of recording the stream data and recording meta information such as a time stamp associated to the stream data.

Further, the HDD recorder has been advanced to be sophisticated in recent years. For example, by providing a plurality of digital tuners or a network I/F, it is going to be possible to always record the stream data of all the received contents in the HDD, record the other stream data in the HDD while watching one stream data, and deliver the stream data stored in the HDD to the other digital device via a network while executing these operations.

### SUMMARY OF THE INVENTION

As mentioned above, even under the condition that the I/O is concentrated on a storage device such as the HDD or the network I/F, it is necessary to ensure the bit rate of each of the stream data and further enable the reading and writing of non-stream data. Therefore, a load on the host CPU related to the I/O process becomes higher and higher.

As one method for solving the problem, there can be considered a method of increasing the frequency band of the bus and the buffer memory quantity or introducing a high-spec CPU mounting a plurality of processor cores thereon. However, since such a method causes an increase of a part cost, power consumption and calorific power and an increase of a design and inspection man hours, it is not a countermeasure preferable for the consumer-oriented digital device.

On the other hand, in a digital device such as the HDD decoder 91 (FIG. 9) handling the contents of the digital broadcasting, in order to deliver the stream data of a paid content on a so-called user access bus such as the general bus 26 or the ATA I/F 32 in accordance with an association of radio industries and businesses (ARIB) standard, it is necessary to encrypt the data so as to prevent an unauthorized use.

For its achievement, the host means except the memory 28 is achieved by one specific LSI (an application specific integrated circuit (ASIC)) so as to prevent the general bus 26 from being easily traced, and the ASIC provided with an encryption/decryption process in the ATA I/F 32 is also manufactured. However, since the ASIC mentioned above is configured so as to consolidate a lot of functions, a chip size thereof is large, and since it is formed as hardware, it is not easy to customize the functions, and the ASIC is very expensive.

Accordingly, an object of the present invention is to provide a stream data control module capable of easily achieving a function expansion of a digital device provided with a storage device such as an HDD or a semiconductor flash memory and capable of simply, safely and inexpensively achieving the recording and reproducing of stream data to and from the storage device.

The above and other objects and novel characteristics of the present invention will be apparent from the description of this specification and the accompanying drawings.

The typical ones of the inventions disclosed in this application will be briefly described as follows.

For example, the present invention provides a stream processing device mutually transferring data including stream data and non-stream data between host means and storage means storing the data, comprising: a first interface unit inputting and outputting the stream data to and from the host means; a second interface unit inputting and outputting the non-stream data to and from the host means; a third interface unit inputting and outputting the stream data and the non-stream data to and from the storage means; a meta information extracting unit extracting meta information from a header portion of the stream data input from the first interface unit; a memory unit buffering the stream data and the non-stream data to be transferred; and a control unit transferring the stream data via the first interface unit and the third interface unit, wherein the control unit comprises: a stream arrangement management unit determining and managing a storing position of the stream data and the meta information in the storage means; a scheduling unit controlling a transfer order of the stream data and the non-stream data to be transferred; and a command processing unit interpreting a control command given from the host means.

The effects obtained by typical aspects of the present invention will be briefly described below.

According to the present invention, by applying a stream date control module to the digital device and the storage device, a simple command interface is provided to the host CPU, and it is possible to release the host CPU from an I/O process of the stream data to the storage device.

As a result, it is possible to additionally mount the function unique to the set vendor of the digital device even in the host CPU having the same spec as that of the conventional one, and it is also possible to replace a CPU with an inexpensive host CPU having the lower spec. Therefore, it is possible to achieve the function improvement while suppressing a cost increase of the digital device.

Further, since the stream data control module is provided with the interface which can input and output the stream data directly without through the general bus, it is possible to more securely handle the stream data.

Further, according to the present invention, the stream data control module can encrypt the stream data because it is provided with the code processing means. Accordingly, the contents with copyright can be safely transmitted to/from the storage device.

Further, according to the present invention, since the stream data control module is provided with a plurality of first interface means which can exclusively input and output the stream data, the stream data control module can be connected to a plurality of supply destinations of the stream data (for example, the A/V decoder and the network I/F) and a plurality of supply sources of the stream data (for example, the digital tuner and the network I/F), and the function expansion can be easily achieved.

### BRIEF DESCRIPTIONS OF THE DRAWINGS

FIG. 1 is a configuration diagram showing the configuration of a stream data control module according to a first embodiment of the present invention;

FIG. 2 is a configuration diagram showing the configuration of a digital device to which the stream data control module is applied according to the first embodiment of the present invention;

FIG. 3 is a diagram showing the configuration of an HDD recorder mounting a streaming HDD to which the stream data control module is applied according to the first embodiment of the present invention;

FIG. 4 is a diagram showing the configuration of a cellular phone having a function capable of receiving, recording and reproducing the one segment broadcasting, to which the stream data control module is applied according to the first embodiment of the present invention;

FIG. 5 is a configuration diagram showing the configuration of a stream data control module according to a second embodiment of the present invention;

FIG. 6 is a configuration diagram showing the configuration of a stream data control module according to a third embodiment of the present invention;

FIG. 7 is a configuration diagram showing the configuration of a digital device to which the stream data control module is applied according to the third embodiment of the present invention;

FIG. 8 is a diagram showing the configuration of an HDD recorder mounting a streaming HDD to which the stream data control module is applied according to the third embodiment of the present invention; and

FIG. 9 is a configuration diagram showing the configuration of a conventional HDD recorder that records and reproduces the stream data.

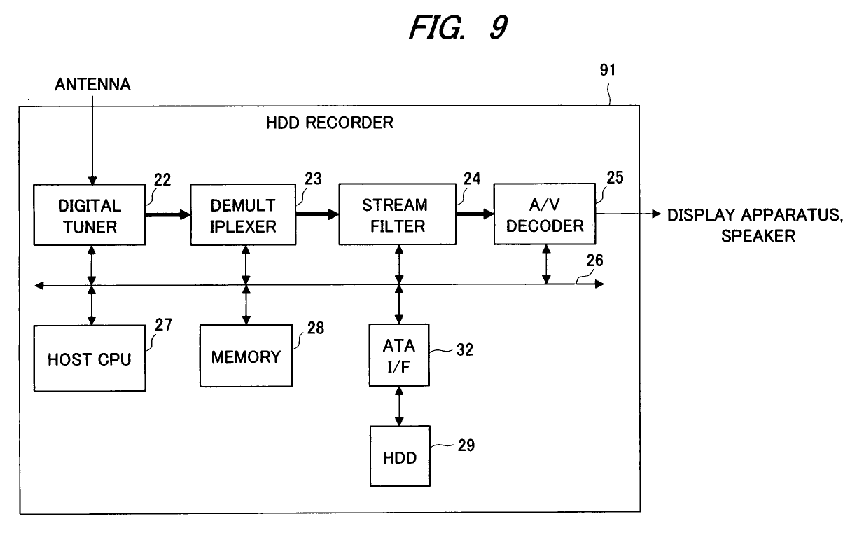

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiment, and the repetitive description thereof will be omitted.

### First Embodiment

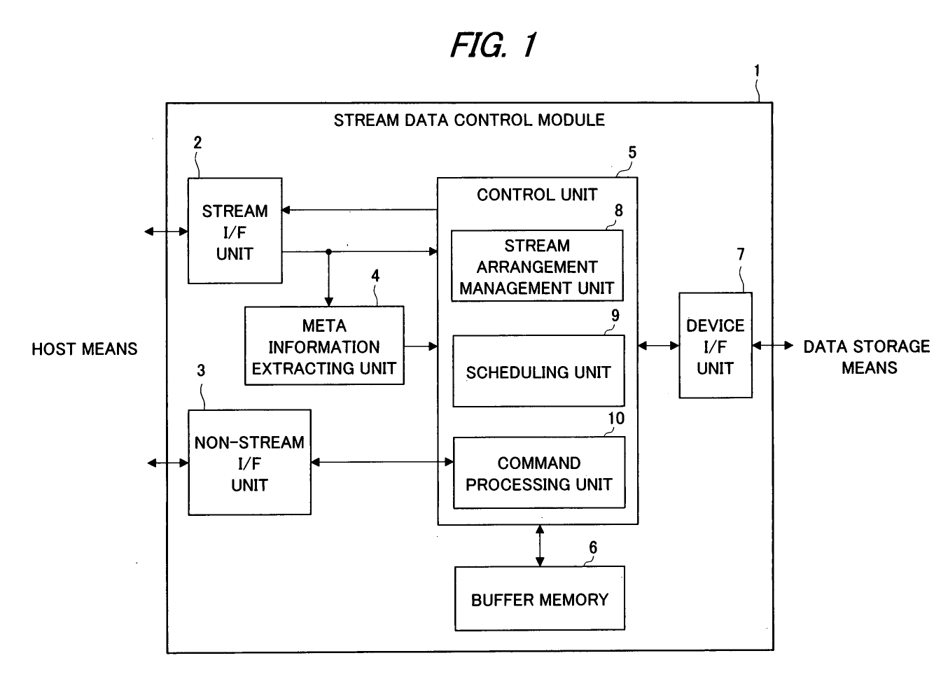

The configuration of a stream data control module according to a first embodiment of the present invention will be described with reference to FIG. 1. FIG. 1 is a configuration diagram showing the configuration of the stream data control module according to the first embodiment of the present invention.

In FIG. 1, a stream data control module 1 is disposed between host means and data storage means. Alternatively, the stream data control module 1 may be configured to be a part of the host means or a part of the data storage means.

The host means mentioned here is a digital device, for example, a personal computer (PC), an HDD recorder, an HDD camcorder, a cellular phone, a portable audio player, a surveillance camera or the like.

Further, the data storage means is a storage device for recording user data such as image, music, photograph, text and the like handled by each of the digital devices, a use quantity of a CPU and a memory provided in the digital device, an OS managing an I/O operation, an application program such as a viewer or a GUI, and metadata associated with the user data. More specifically, the data storage means is, for example, a magnetic disk such as the HDD, a magneto-optical disk such as a digital versatile disk (DVD) or a Blu-Ray disc, a semiconductor flash memory such as an SD memory card.

The stream data control module 1 includes a stream I/F unit 2 corresponding to first interface means, a non-stream I/F unit 3 corresponding to second interface means, a meta information extracting unit 4 corresponding to meta information extracting means, a control unit 5 corresponding to control means, a buffer memory 6, and a device I/F unit 7 corresponding to third interface means.

The stream I/F unit 2 provides an interface for simultaneously inputting and outputting a plurality of stream data such as image and music to and from the host means, and it transfers the stream data, which the control unit 5 outputs in accordance with each bit rate, for example, 20 Mbps or 128 kbps, to the host means and also transfers the stream data delivered by the host means to the meta information extracting unit 4 and the control unit 5.

A concrete specification of the stream I/F unit 2 is a parallel interface inputting and outputting TS or program stream (PS), compressed digital data of a TS type with time stamp by 8 bits or a serial interface inputting and outputting the same by 1 bit.

The non-stream I/F unit 3 provides an interface for inputting and outputting non-stream data other than the stream data such as photograph and text data and further a control command including an address for recording the photograph and the text data in the data storage means to and from the host means, and it transfers the non-stream data output by the control unit 5 to the host means and transfers the non-stream data delivered by the host means to the control unit 5.

A concrete specification of the non-stream I/F unit 3 is a general bus such as an ATA, a consumer electronics ATA (CE-ATA) which is an ATA directed to a built-in device, a universal serial bus (USB), a peripheral component interconnect (PCI) or the like.

The meta information extracting unit 4 analyzes a header portion added to the stream data output by the stream I/F unit 2 and generates meta information data including a type (voice, image or the like) of the stream data, time stamp information of the frame, the number of bites per one frame and the like. The meta information data is referred by the control unit 5 in the case of reproducing the stream data recorded in the data storage means, particularly in the case of executing a special reproduction such as fast forward or rewind.

The buffer memory 6 is a memory temporarily storing the stream data, the non-stream data, and the meta information data.

The device I/F unit 7 provides an interface inputting and outputting the stream data, the non-stream data and the meta information data to and from the data storage means, and it transfers the various data output by the control unit 5 to the data storage means and transfers the various data stored in the data storage means to the control unit 5.

A concrete specification of the device I/F unit 7 changes depending on the format of the data storage means and is, for example, a parallel ATA or a serial ATA in the case of the HDD and an SD card I/F in the case of the SD memory. Further, it may be the USB, IEEE (the institute of electrical and electronics engineers, Inc.) 1394 or the like.

The control unit 5 manages the information associated with the operation of the stream data control module 1 and executes the operations on the basis of the information. Also, it includes a stream arrangement management unit 8 corresponding to stream arrangement management means, a scheduling unit 9 corresponding to schedule means, and a command processing unit 10 corresponding to command processing means.

The stream arrangement management unit 8 is a file system related to the stream data, and it is used for updating and managing a free space (a used space) of the data storage means and attribute information such as a name, an access date and hour and the like of the recorded stream data and meta information data, determining a storage destination address for recording the stream data and the meta information data in the data storage means, and specifying a storing position of the recorded data.

In the stream data control module 1 according to the present embodiment, the host means executes the data arrangement management of the non-stream data.

The stream arrangement management unit 8 can change a storing method of the stream data in accordance with the feature of the data storage means. For example, in the case where the data storage means is the HDD, a reading speed of the data recorded only in an inner peripheral portion of the disk is lowered to one third to one fifth of a reading speed of the data recorded only in an outer peripheral portion. Accordingly, by applying a method of regularly dispersing and recording the stream data on the disk, any stream data can be acquired at a uniform reading speed.

Further, in the case where the data storage means is the flash memory, since there is a limitation in the number of rewritings of a block, the lifetime of the flash memory can be lengthened by applying a method in which the stream data are recorded evenly in the used blocks.

The scheduling unit 9 controls a timing for transferring the stream data, the non-stream data and the meta information data to the data storage means and acquiring the data from the data storage means and gives priority to the process of the stream data in the case where the competition of the stream data and the non-stream data occurs. Further, in the case where the competition of the simultaneous recording (writing) of a plurality of stream data, the simultaneous reproducing (reading) of a plurality of stream data and the simultaneous recording and reproducing of a plurality of stream data occurs, the scheduling unit 9 adjusts the competition by processing the stream data to be recorded and reproduced per a predetermined unit in a sequential order when only the simultaneous recording or the simultaneous reproducing is to be executed and by processing the stream data to be reproduced by priority when the simultaneous recording and reproducing are to be executed.

The command processing unit 10 analyzes the control command given from the host means via the non-stream I/F unit 3, determines the transfer of the control command to the data storage means, generates a control command newly issued to the data storage means, and generates a response message to the host means.

The main control commands which the command processing unit 10 of the present embodiment accepts from the host means are, for example, a write command for recording non-stream data such as photograph and text data in the data storage means, a recording command for recording stream data such as image, a read command for acquiring predetermined non-stream data stored in the data storage means, a reproducing command for acquiring predetermined stream data, a special reproducing command including arbitrary reproduction start time, reproducing direction (fast forward and rewinding) and reproducing speed (fast forward and rewinding speeds and temporary stop) in the predetermined stream data as a part of the reproducing command, and a stop command for suspending the acquisition of the stream data.

The stream data control module 1 can be achieved in the form of one chip with a specific LSI or a field programmable gate array (FPGA) or by a plurality of chips. Alternatively, the stream data control module 1 can be achieved to have a configuration in which the part except the buffer memory 6 is formed by one chip with the special LSI or the FPGA or by a plurality of chips and the buffer memory 6 is formed by a volatile memory such as a dynamic random access memory (DRAM) or a non-volatile memory such as a flash memory.

Further, the control unit 5 is constituted by a general processor, and the stream arrangement management unit 8, the scheduling unit 9 and the command processing unit 10 can be achieved by software programs operating on the processor.

The operation and function of the control unit 5 will be described below with reference to each of the control commands.

(1) Write Command

The operation of this control command corresponds to the recording of non-stream data such as photograph and text data to the data storage means.

In the case where the result of analysis in the command processing unit 10 is the write command, the control unit 5 immediately transfers the write command to the data storage means via the device I/F unit 7. Subsequently, the control unit 5 transfers the write data transferred from the non-stream I/F unit 3 to the data storage means via the device I/F unit 7 in the same manner as the write command. In this case, if the process competes with a process such as the recording or the reproducing of the stream data, the control unit 5 queues the write command so as to process the stream data by priority, and the queued write command is sequentially processed in accordance with the command of the scheduling unit 9.

On the other hand, when the control unit 5 receives the response message to the write command from the data storage means, the control unit 5 transfers the response message to the host means via the non-stream data I/F unit 3.

(2) Recording Command

The operation of this control command corresponds to the recording of stream data such as the image data to the data storage means, and it corresponds to the recording of a broadcasting content obtained by the reception of a terrestrial digital broadcasting by the host means or an internet protocol (IP) broadcasting content via a network.

In the case where the result of analysis in the command processing unit 10 is the recording command, the control unit 5 searches a free space for recording the stream data and the meta information data by referring to the information held by the stream arrangement management unit 8 and acquires respective storage destination addresses thereof. Then, by notifying the command processing unit 10 that the transfer of the stream data and the meta information data to the data storage means is ready, the response message to the recording command is generated in the command processing unit 10.

Next, when the control unit issues the response message to the host means via the non-stream I/F unit 3, the stream data received via the stream I/F unit 2 and the meta information data output by the meta information extracting unit 4 are sequentially stored in the buffer memory 6.

When the stream data stored in the buffer memory 6 reaches a predetermined size, the stream data is sequentially transferred to the data storage means together with the write command generated by the command processing unit 10 via the device I/F unit 7, and this operation is repeatedly executed until the stream data delivered from the host means is finished. The meta information data stored in the buffer memory 6 is also sequentially transferred to the data storage means together with the write command generated by the command processing unit 10 via the device I/F unit 7 in the same manner as the stream data.

The control unit 5 is provided with a mechanism, which stores the response messages to each of the write data received from the data storage means to hold the information about whether the recording is made normally or partially fails and can respond to an inquiry from the host means.

(3) Read Command

The operation of this control command corresponds to the reading of a photograph, text data and the like recorded in the data storage means.

In the case where the result of analysis in the command processing unit 10 is the read command, the control unit 5 immediately transfers the read command to the data storage means via the device I/F unit 7.

When the control unit 5 receives the read data delivered from the data storage means via the device I/F unit 7, the control unit 5 transfers the read data to the host means via the non-stream I/F unit 3.

However, in the case where this operation competes with the recording or the reproducing of the stream data, the control unit 5 temporarily stores the read data in the buffer memory in accordance with the command of the scheduling unit 9 and processes the stream data by priority.

(4) Reproducing/Special Reproducing Command

The operation of this control command corresponds to the reproducing of the stream data which the host means records in the data storage means and the delivery for providing the stream data to other built-in device via the network.

In the case where the result of analysis in the command processing unit 10 is the reproducing command, the control unit 5 acquires the storage destination addresses of the stream data and the meta information table with reference to the information held by the stream arrangement management unit 8 on the basis of a content name provided simultaneously with the reproducing command. Then, by notifying the command processing unit 10 that the acquisition of the predetermined stream data (content) from the data storage means is ready, the response message to the reproducing command is generated in the command processing unit 10.

Next, the control unit 5 issues the response message to the host means via the non-stream I/F unit 3, sequentially issues the read command including the address generated by the command processing unit 10 to the data storage means via the device I/F unit 7, and sequentially stores the received stream data in the buffer memory.

The stream data stored in the buffer memory is read out in accordance with the bit rate thereof, for example, 20 Mbps and transferred to the host means via the stream I/F unit 2.

On the other hand, in the case where the result of analysis in the command processing unit 10 is the special reproducing command, the control unit 5 acquires the storage destination addresses of the predetermined stream data and the meta information table thereof on the basis of the content name provided simultaneously with the reproducing command. Then, by notifying the command processing unit 10 that the acquisition of the predetermined stream data (content) from the data storage means is ready, the response message to the special reproducing command is generated in the command processing unit 10.

Next, the control unit 5 issues the response message to the host means via the non-stream I/F unit 3, sequentially issues the read command including the address information generated by the command processing unit 10 to the data storage means via the device I/F unit 7 for first acquiring the meta information data, and stores the received meta information data in the buffer memory 6.

The control unit 5 refers to the acquired meta information data to generate the address in accordance with designated reproduction start time, reproducing direction and reproducing speed, sequentially issues the read command including the address to the data storage means via the device I/F unit 7, and sequentially stores the received stream data in the buffer memory or directly transfers the stream data to the host means via the stream I/F unit 2 depending on the reproducing speed.

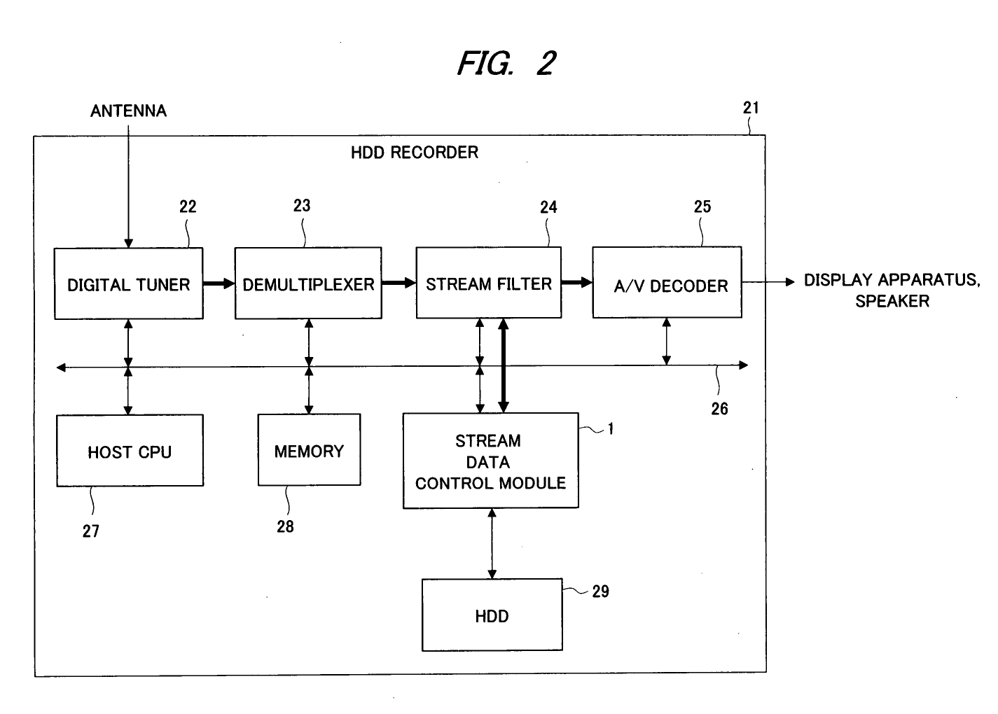

Next, the configuration and function of a digital device to which the stream data control module according to the first embodiment of the present invention is applied will be described with reference to FIG. 2. FIG. 2 is a configuration diagram showing the configuration of the digital device to which the stream data control module according to the first embodiment of the present invention is applied, and it illustrates an HDD recorder 21 to which the stream data control module 1 is applied.

In FIG. 2, the HDD recorder 21 includes the digital tuner 22 constituting the host means, the demultiplexer 23, the stream filter 24, the A/V decoder 25, the host CPU 27, the memory 28, the stream data control module 1, and the HDD 29 constituting the data storage means. Also, the digital tuner 22, the demultiplexer 23, the stream filter 24, the A/V decoder 25, the host CPU 27, the memory 28 and the stream data control module 1 are connected to each other via the general bus 26, and necessary commands and data can be exchanged through the bus 26.

Further, the stream filter 24 and the stream data control module 1 are directly connected by the stream I/F unit 2 of the stream data control module 1, and the stream data can be exchanged without through the general bus 26.

In the HDD recorder 21 to which the stream data control module 1 is applied, when the received digital broadcasting contents are to be recorded, the host CPU 27 is only required to issue the recording command to the stream data control module 1. By the recording command, the stream data control module 1 autonomously transfers and records the TS output by the stream filter 24 to the HDD 29.

Further, when the contents recorded in the HDD 29 are to be reproduced, the host CPU 27 is only required to issue the reproducing command including the content name to the stream data control module 1. By the reproducing command, the stream data control module 1 autonomously reads out the designated contents from the HDD 29 in accordance with the bit rate and transfers the contents to the stream filter 24.

Further, it is possible to perform the simultaneous writing of the stream data and the meta information associated with the stream data.

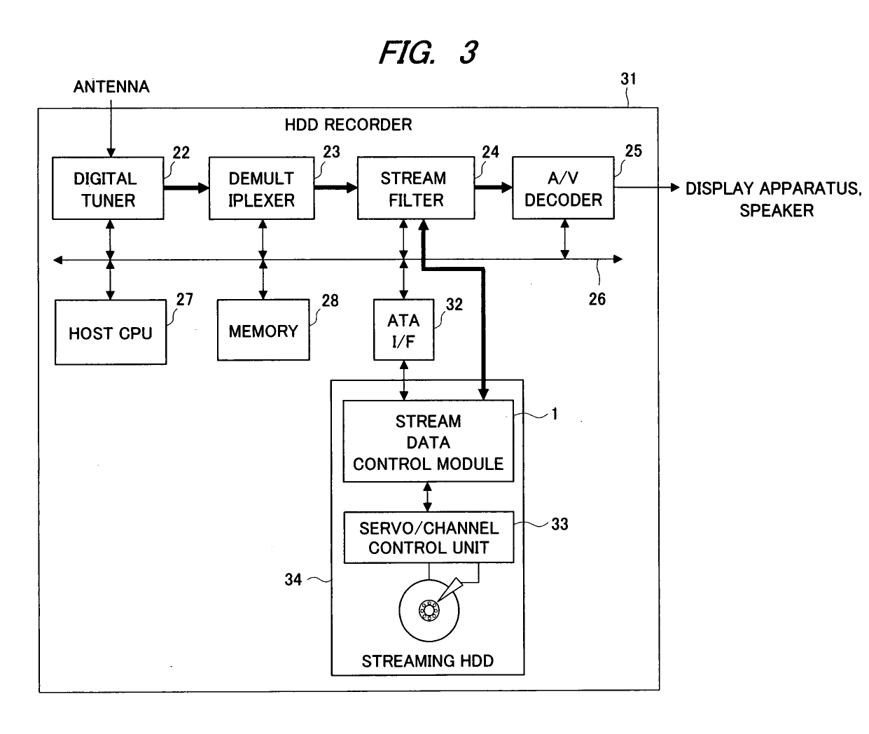

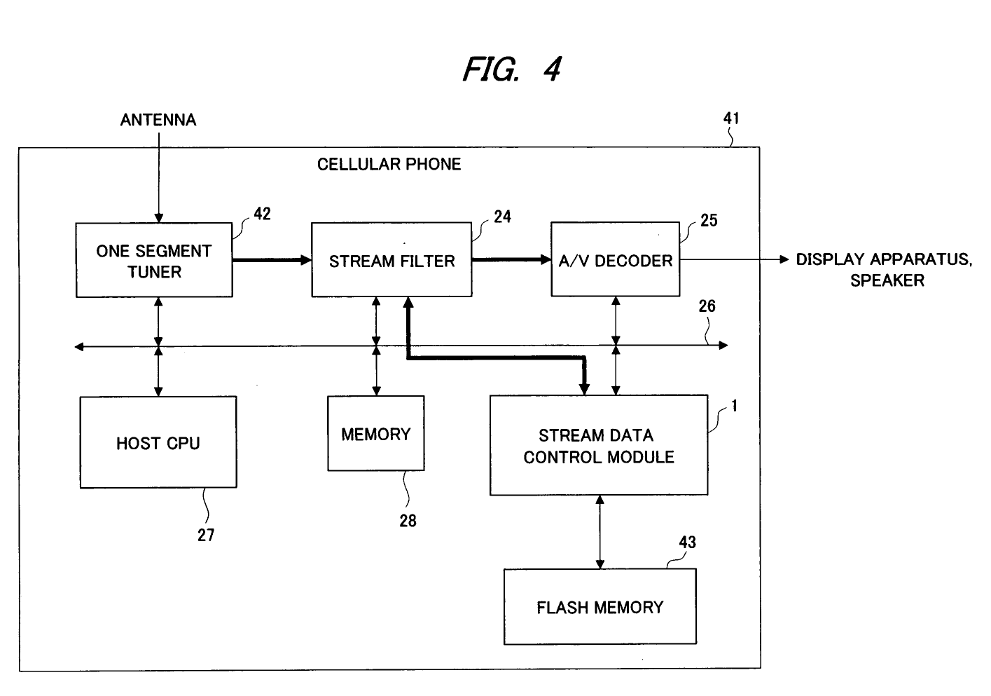

Next, other examples of the digital device to which the stream data control module according to the first embodiment of the present invention is applied will be described with reference to FIGS. 3 and 4. FIG. 3 is a diagram showing the configuration of an HDD recorder mounting a streaming HDD to which the stream data control module according to the first embodiment of the present invention is applied, and FIG. 4 is a diagram showing the configuration of a cellular phone provided with a function capable of receiving, recording and reproducing one segment broadcasting, to which the stream data control module in accordance with the first embodiment of the present invention is applied. In FIG. 4, functional units related to a user interface such as a telephone receiver, a telephone transmitter and a numeric keypad are omitted.

In FIG. 3, the HDD recorder 31 includes the digital tuner 22 constituting the host means, the demultiplexer 23, the stream filter 24, the A/V decoder 25, the host CPU 27, the memory 28, the ATA I/F 32, and a streaming HDD 34 constituting the data storage means. Also, the digital tuner 22, the demultiplexer 23, the stream filter 24, the A/V decoder 25, the host CPU 27, the memory 28 and the ATA I/F 32 are connected to each other via the general bus 26, and necessary commands and data can be exchanged through the bus 26.

Further, the stream filter 24 and the stream data control module 1 in the streaming HDD 34 are directly connected by the stream I/F unit 2 of the stream data control module 1, and the stream data can be exchanged without through the general bus 26.

The streaming HDD 34 is provided with the stream data control module 1 in place of the interface unit in the conventional HDD and has the configuration where the stream data control module 1 is connected to a servo/channel control unit 33 which controls a magnetic head, a spindle motor and the like and modulates and demodulates the write/read data.

In the HDD recorder 31 employing the streaming HDD 34 provided with the stream data control module 1 as mentioned above, when the received digital broadcasting contents are to be recorded, the host CPU 27 is only required to write a recording command or a unique command corresponding to a recording command defined as a vendor expansion into a command register provided in the ATA I/F 32. By the command, the streaming HDD 34 provided with the stream data control module 1 autonomously records the TS output by the stream filter 24.

Further, when the contents recorded in the streaming HDD 34 are to be reproduced, the host CPU 27 is only required to write the reproducing command or the unique command corresponding to the reproducing command defined as the vendor expansion and including the reproduction start time, the reproducing direction and the reproducing speed into the command register provided in the ATA I/F 32. By the command, the streaming HDD 34 autonomously transfers the designated contents to the stream filter 24 in accordance with the bit rate.

In FIG. 4, the cellular phone 41 includes a one segment tuner 42 constituting the host means, the stream filter 24, the A/V decoder 25, the host CPU 27, the memory 28, the stream data control module 1, and a flash memory 43 constituting the data storage means. Also, the one segment tuner 42, the stream filter 24, the A/V decoder 25, the host CPU 27, the memory 28 and the stream data control module 1 are connected to each other via the general bus 26, and necessary commands and data can be exchanged through the bus 26.

Further, the stream filter 24 and the stream data control module 1 are directly connected by the stream I/F unit 2 of the stream data control module 1, and the stream data can be exchanged without through the general bus 26.

When the digital broadcasting contents received by the antenna are to be watched in the cellular phone 41, the TS output of the one segment tuner 42 selects a target program or service in the stream filter 24 and is transferred to the A/V decoder 25. In the A/V decoder 25, the decoding is performed in accordance with an encoding method of compressed digital data, for example, the MPEG-2, the MPEG-4 or the AAC, and the decoded data are output to the display apparatus and the speaker.

In the cellular phone 41 to which the stream data control module 1 mentioned above is applied, when the received digital broadcasting contents are to be recorded, the host CPU 27 is only required to issue the recording command to the stream data control module 1. By the recording command, the stream data control module 1 autonomously transfers and records the TS output by the stream filter 24 to the flash memory 43.

Further, when the contents recorded in the flash memory 43 are to be reproduced, the host CPU 27 is only required to issue the reproducing command to the stream data control module 1. By the reproducing command, the stream data control module 1 autonomously reads out the designated contents from the flash memory 43 in accordance with the bit rate and transfers the contents to the stream filter 24.

The stream arrangement management unit 8 of the stream data control module 1 in the cellular phone 41 can employ a method in which the stream data are arranged so as to average the number of rewritings of the blocks as mentioned above.

As mentioned above, according to the present embodiment, since the stream I/F unit 2 exclusively inputting and outputting the stream data is provided in the stream data control module 1, it is possible to transmit the stream data with the stream filter 24 directly without through the general bus 26. Therefore, it is possible to release the CPU 27 from the complicated I/O process to the storage device.

### Second Embodiment

In a second embodiment, the configuration of the first embodiment is modified so that a coding process is executed in the control unit of the stream data control module 1.

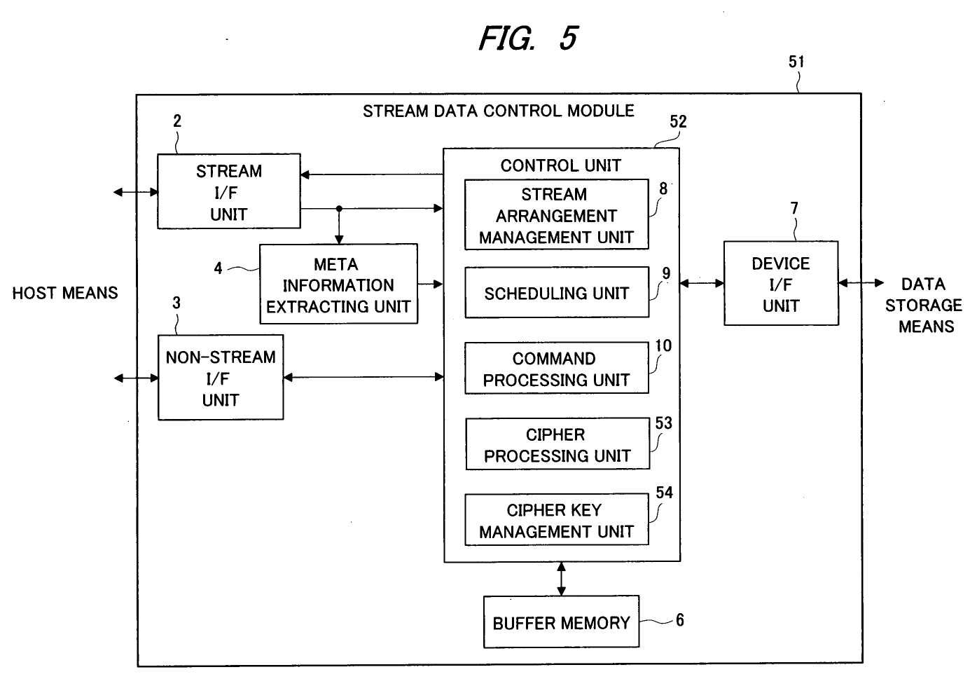

The configuration of a stream data control module according to the second embodiment of the present invention will be described with reference to FIG. 5. FIG. 5 is a configuration diagram showing the configuration of the stream data control module according to the second embodiment of the present invention.

In FIG. 5, in comparison with the control unit 5 of the stream data control module 1 shown in FIG. 1, a stream data control module 51 includes a control unit 52 provided with a cipher unit 53 corresponding the code processing means and a cipher key management unit 54, and other components are the same as those of the first embodiment.

In the stream data control module 51, since the stream I/F unit 2, the non-stream I/F unit 3, the meta information extracting unit 4, the buffer memory 6, and the device I/F unit 7 are the same as those of the first embodiment, the description will be given below only for the configuration of the control unit 52.

The cipher unit 53 codes the stream data delivered by the host means in accordance with a predetermined coding method or decodes the coded stream data recorded in the data storage means.

The cipher key management unit 54 manages a cipher key to each of the stream data, and the cipher key is transmitted with the host means via the non-stream I/F unit 3.

In the cipher unit 53, a coding function such as an advanced encryption standard (AES) or a data encryption standard (DES) and a hash function used for detecting interpolation such as a secure hash algorithm 1 (SHA-1) are mounted as a software program such as a hardware logic, a hardware logic capable of being constructed in a reconfigurable manner or an assembler.

Further, the cipher unit 53 can be turned ON/OFF (validated/invalidated) in accordance with the command from the host means via the non-stream I/F unit 3, and the stream data for which the encryption is not necessary can be recorded as it is in the data storage means.

The control unit 52 executes the coding process by the cipher unit 53 at the time of giving the stream data stored in the buffer memory 6 to the device I/F unit 7 in response to the recording command. Further, the control unit 52 acquires the cipher key from the cipher key management unit 54 in response to the reproducing/special reproducing command, and executes the decoding process by the cipher unit 53 before storing the stream data read out from the data storage means in the buffer memory 6.

As another method, the control unit 52 executes the decoding process by the cipher unit 53 at the time of giving the encryption stream data stored in the buffer memory 6 to the stream I/F unit 2. As described above, the unfair watching can be suppressed by coding the stream data recorded in the data storage means, and the stream data can be safely stored even in the case where the copyright subsists.

### Third Embodiment

In a third embodiment, the configuration of the second embodiment is modified so that a plurality of steam I/F units are provided.

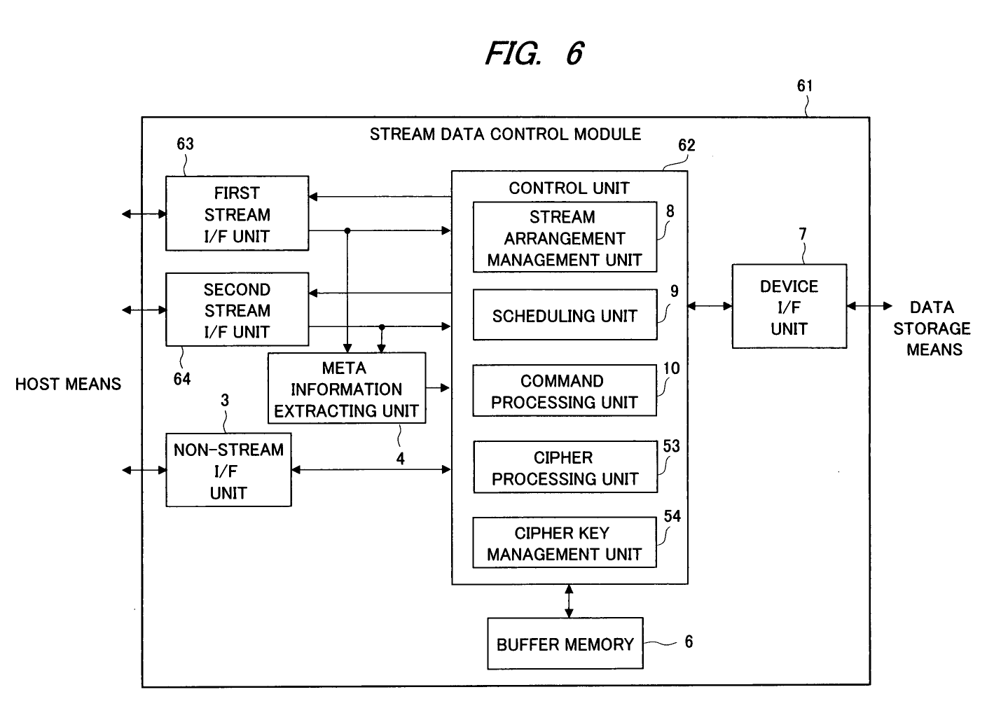

The configuration of a stream data control module according to the third embodiment of the present invention will be described with reference to FIG. 6. FIG. 6 is a configuration diagram showing the configuration of the stream data control module according to the third embodiment of the present invention.

In FIG. 6, a stream data control module 61 is provided with two or more input stream I/F units (a first stream I/F unit 63 and a second stream I/F unit 64 in the embodiment shown in FIG. 6) instead of the stream I/F unit 2 of the stream data control module 51 shown in FIG. 5.

The cooperating operation of a control unit 62, the first stream I/F unit 63 and the second stream I/F unit 64 will be described below.

The stream data delivered by the host means includes, for example, a terrestrial digital broadcasting content provided via an antenna and an IP broadcasting content provided via a network, and there is the host means having different supply sources for each stream data as mentioned above. For the host means as mentioned above, the stream data control module 61 is configured so as to accept the stream data of the terrestrial digital broadcasting content by the first stream I/F unit 63 and accept the stream data of the IP broadcasting content by the second stream I/F unit 64.

Further, there are the case where the stream data accepted by the host means is reproduced by the host means and the case where the network means is provided and the stream data is delivered to other built-in device on the network. As mentioned above, and there is the host means having the different supply destinations for each stream data.

For the host means as mentioned above, the control unit 62 of the stream data control module 61 is configured so as to output the stream data from the first stream I/F unit 63 in the case of receiving the reproducing command for executing the local reproduction from the host means, and output the stream data from the second stream I/F unit 64 in the case of receiving the reproducing command (the delivering command) for executing the delivery from the host means to the network.

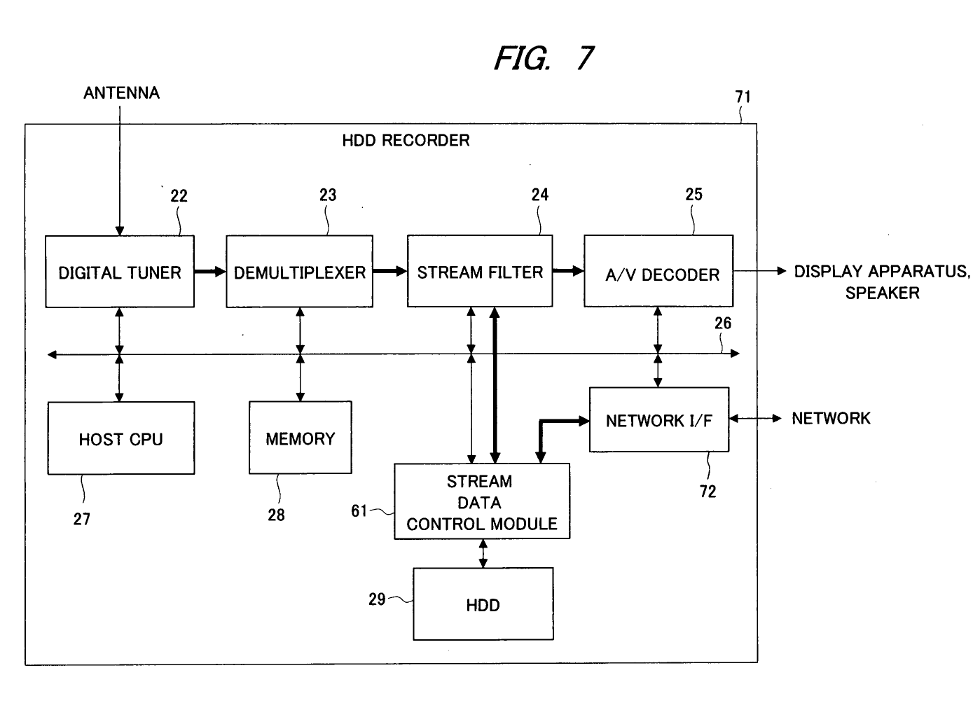

Next, the configuration and function of a digital device to which the stream data control module according to the third embodiment of the present invention is applied will be described with reference to FIG. 7. FIG. 7 is a configuration diagram showing the configuration of the digital device to which the stream data control module according to the third embodiment of the present invention is applied, and it illustrates an HDD recorder 71 to which the stream date control module 61 is applied.

In FIG. 7, the HDD recorder 71 includes the digital tuner 22 constituting the host means, the demultiplexer 23, the stream filter 24, the A/V decoder 25, the host CPU 27, the memory 28, the stream data control module 61, a network I/F 72 capable of inputting and outputting the TS, and the HDD 29 constituting the data storage means. Also, the digital tuner 22, the demultiplexer 23, the stream filter 24, the A/V decoder 25, the host CPU 27, the memory 28, the stream data control module 61 and the network I/F 72 are connected to each other via the general bus 26, and necessary commands and data can be exchanged through the bus 26.

Further, the stream filter 24 and the stream data control module 61 are directly connected by the first stream I/F unit 63 of the stream data control module 61 and the network I/F 72 and the stream data control module 61 are directly connected by the second stream I/F unit 64 of the stream data control module 61, and the stream data can be exchanged without through the general bus 26.

In the HDD recorder 71 to which the stream data control module 61 is applied as mentioned above, when the received digital broadcasting contents are to be recorded, the host CPU 27 is only required to issue the recording command for the terrestrial digital broadcasting content and the reproducing command in the HDD recorder 71 to the stream data control module 61. By this means, the stream data control module 61 autonomously transfers and records the TS output by the stream filter 24 to the HDD 29, and also autonomously reads out the designated contents from the HDD 29 in accordance with the bit rate and transfers the contents to the stream filter 24.

In addition, if the host CPU 27 just issues the recording command for the IP broadcasting contents from the network I/F 72 and the delivering command to the network, the stream data control module 61 autonomously transfers and records the TS output by the network I/F 72 in the HDD 29, and also autonomously reads out the designated contents from the HDD 29 in accordance with the bit rate and transfers the contents to the network I/F 72.

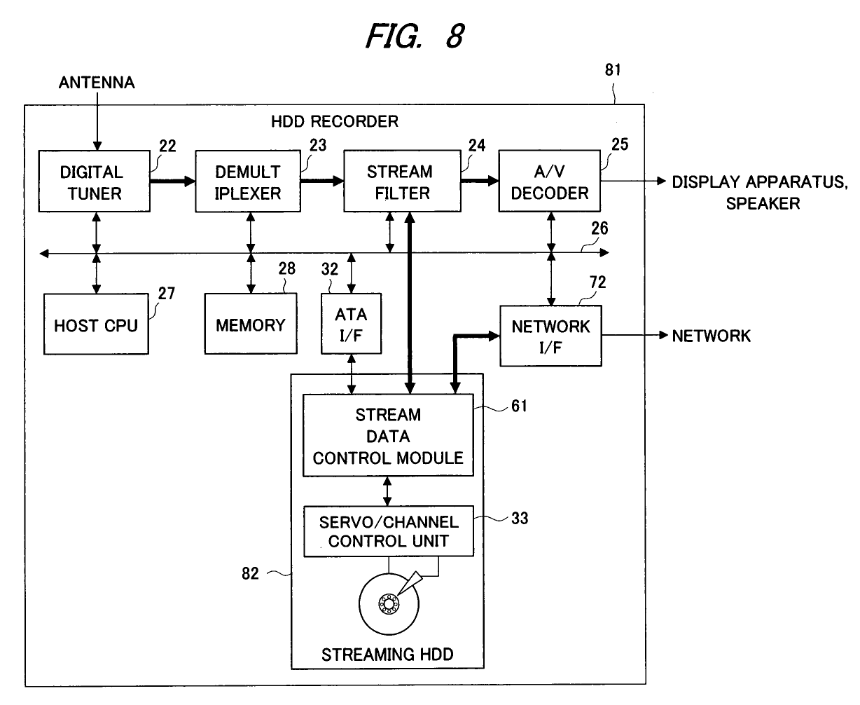

Next, another example of the digital device to which the stream data control module according to the third embodiment of the present invention is applied will be described with reference to FIG. 8. FIG. 8 is a diagram showing the configuration of an HDD recorder mounting a streaming HDD to which the stream data control module according to the third embodiment of the present invention is applied.

In FIG. 8, an HDD recorder 81 includes the digital tuner 22 constituting the host means, the demultiplexer 23, the stream filter 24, the A/V decoder 25, the host CPU 27, the memory 28, the ATA I/F 32, the network I/F 72 capable of inputting and outputting the TS, and a streaming HDD 82 constituting the data storage means. Also, the digital tuner 22, the demultiplexer 23, the stream filter 24, the A/V decoder 25, the host CPU 27, the memory 28, the ATA I/F 32 and the network I/F 72 are connected to each other via the general bus 26, and necessary commands and data can be exchanged through the bus 26.

Further, the stream filter 24 and the stream data control module 61 in the streaming HDD 82 are directly connected by the first stream I/F unit 63 of the stream data control module 61 and the network I/F 72 and the stream data control module 61 in the streaming HDD 82 are directly connected by the second stream I/F unit 64 of the stream data control module 61, and the stream data can be exchanged without through the general bus 26.

The streaming HDD 82 is provided with the stream data control module 61 in place of the interface unit of the conventional HDD and the stream data control module 61 is configured to be connected to the servo/channel control unit 33 which controls the magnetic head and the spindle motor and modulates and demodulates the write/read data.

In the HDD recorder 81 employing the streaming HDD 82 provided with the stream data control module 61 as mentioned above, when the received digital broadcasting contents are to be recorded, the host CPU 27 is only required to write the recording command or a unique command corresponding to the recording command defined as a vendor expansion in the command register provided in the ATA I/F 32. By the command, the streaming HDD 82 provided with the stream data control module 1 autonomously records the TS output by the stream filter 24.

Further, when the contents recorded in the streaming HDD 82 are to be reproduced, the host CPU 27 is only required to write the reproducing command or the unique command corresponding to the reproducing command defined as the vendor expansion and including the reproduction start time, the reproducing direction and the reproducing speed into the command register provided in the ATA I/F 32. By the command, the streaming HDD 82 autonomously transfers the designated contents to the stream filter 24 in accordance with the bit rate.

In addition, if the host CPU 27 just issues the recording command for the IP broadcasting contents from the network I/F 72 and the delivering command to the network, the stream data control module 61 autonomously transfers and records the TS output by the network I/F 72 in the HDD 29, and also autonomously reads out the designated contents from the HDD 29 in accordance with the bit rate and transfers the contents to the network I/F 72.

Further, in the stream data control module 61, it is possible to easily add the network I/F 72 to the HDD recorder 21 shown in FIG. 2 and the HDD recorder 31 shown in FIG. 3. Since the stream data is not output to the general bus 26, it is possible to stably supply the stream data to the network without narrowing the frequency band of the general bus 26, and it is also possible to stably accept the stream data from the network I/F 72.

In the foregoing, the invention made by the inventors of the present invention has been concretely described based on the embodiments. However, it is needless to say that the present invention is not limited to the foregoing embodiments and various modifications and alterations can be made within the scope of the present invention.

The present invention relates to the stream data control module for recording and reproducing stream data such as image and music for storage devices such as the hard disk drive and the semiconductor flash memory. More particularly, the present invention can be widely applied to the digital device in which the simple, safe and inexpensive recording and reproducing of the stream data are required.

What is claimed is:

1. A stream processing device mutually transferring data including stream data and non-stream data between host means and storage means storing the data, comprising:
a first interface unit inputting and outputting the stream data to and from the host means;
a second interface unit inputting and outputting the non-stream data to and from the host means;
a third interface unit inputting and outputting the stream data and the non-stream data to and from the storage means;
a meta information extracting unit extracting meta information from a header portion of the stream data input from the first interface unit;
a memory unit buffering the stream data and the non-stream data to be transferred; and
a control unit transferring the stream data via the first interface unit and the third interface unit,
wherein the control unit comprises:
a stream arrangement management unit determining and managing a storing position of the stream data and the meta information in the storage means;
a scheduling unit controlling a transfer order of the stream data and the non-stream data to be transferred; and
a command processing unit interpreting a control command given from the host means.

2. The stream processing device according to claim 1,
wherein the stream processing device transfers the stream data input to the first interface unit to the storage means via the third interface unit by issuing a recording command once to stream data transfer means from the host means through the second interface unit when the storage means executes a recording operation, and
the stream processing device acquires the stream data recorded in the storage means through the third interface unit and outputs the stream data to the first interface unit by issuing a reproducing command once to the stream data transfer means from the host means through the second interface unit when the stream processing device executes a reproducing operation.

3. The stream processing device according to claim 2,
wherein the scheduling unit gives priority to a transfer process of the stream data when a transfer process of the stream data competes with a transfer process of the non-stream data.

4. The stream processing device according to claim 1,
wherein the stream arrangement management unit is changeable so as to select an optimum data arranging method in conformity to a feature of the storage means.

5. The stream processing device according to claim 3,
wherein a control command received by the command processing unit from the host means is a reproducing direction, a reproducing speed and a reproducing time of the stream data.

6. The stream processing device according to claim 1,
wherein the first interface unit is plural in number.

7. The stream processing device according to claim 1,
wherein the control unit is provided with a cipher unit which codes and decodes the stream data.

8. The stream processing device according to claim 1,
wherein the storage means is any one of a hard disk device, a non-volatile semiconductor memory and an optical disk device.

9. The stream processing device according to claim 1,
wherein, when the control command analyzed by the command processing unit is a recording command of the stream data,
the stream arrangement management unit acquires a storage destination address of the storage means storing the stream data,
the command processing unit transmits a response message indicating a ready state to the host means, and
the control unit transfers the stream data to the storage means in accordance with a command of the scheduling means.

10. The stream processing device according to claim 1,
wherein, when the control command analyzed by the command processing unit is a reproducing command of the stream data,
the stream arrangement management unit acquires a storage destination address where the stream data corresponding to a content name included in the control command is stored,
the command processing unit transmits a response message indicating a ready state to the host means, and
the control unit transfers the stream data from the storage means in accordance with a command of the scheduling means.

11. The stream processing device according to claim 1,
wherein, when the control command analyzed by the command processing unit is a reproducing command of the stream data,
the control unit transfers the stream data from the storage means to the host means with reference to meta information stored in the storage means.

12. The stream processing device according to claim 1,
wherein the command processing unit receives a control command from the host means via the second interface unit.

13. The stream processing device according to claim 1,
wherein, when receiving the control command, the command processing unit transmits a response message indicating a ready state for the control command to the host means.

14. A storage device connected to host means and storing data including stream data and non-stream data, the storage device comprising:
storage means storing the stream data and the non-stream data;
a first interface unit inputting and outputting the stream data to and from the host means;
a second interface unit inputting and outputting the non-stream data to and from the host means;
a meta information extracting unit extracting meta information from a header portion of the stream data input from the first interface unit;
a memory unit buffering the stream data and the non-stream data to be transferred; and
a control unit which includes: a stream arrangement management unit determining and managing a storage position of the stream data in the storage means;
a scheduling unit controlling a recording or reading order of the stream data and the non-stream data to and from the storage means; and
a command processing unit interpreting various commands given by the second interface unit.

15. The storage device according to claim 14,
wherein the storage device transfers the stream data input to the first interface unit to the storage means by receiving a recording command once from the host means through the second interface unit when the storage means executes a recording operation, and
the storage device outputs the stream data recorded in the storage means to the first interface unit by receiving a reproducing command once from the host means through the second interface unit when the storage device executes a reproducing operation.

16. The storage device according to claim 14,
wherein the scheduling unit gives priority to a transfer process of the stream data when a transfer process of the stream data competes with a transfer process of the non-stream data.

17. The storage device according to claim 14,
wherein the stream arrangement management unit is changeable so as to select an optimum data arranging method in conformity to a feature of the storage means.

18. The storage device according to claim 16,
wherein a control command received by the command processing unit from the host means is a reproducing direction, a reproducing speed and a reproducing time of the stream data.

19. The storage device according to claim 14,
wherein the first interface unit is plural in number.

20. The storage device according to claim 14,
wherein the storage means is provided with a cipher unit which codes and decodes the stream data.

21. The storage device according to claim 14,
wherein the storage means is any one of a hard disk device, a non-volatile semiconductor memory and an optical disk device.

22. The storage device according to claim 14,
wherein, when the control command analyzed by the command processing unit is a recording command of the stream data,
the stream arrangement management unit acquires a storage destination address of the storage means storing the stream data,
the command processing unit transmits a response message indicating a ready state to the host means, and
the storage means stores the stream data in accordance with a command of the scheduling means.

23. The storage device according to claim 14,
wherein, when the control command analyzed by the command processing unit is a reproducing command of the stream data,
the stream arrangement management unit acquires a storage destination address where the stream data corresponding to a content name included in the control command is stored,
the command processing unit transmits a response message indicating a ready state to the host means, and
the storage means outputs the stream data in accordance with a command of the scheduling means.

24. The storage device according to claim 14,
wherein, when the control command analyzed by the command processing unit is a reproducing command of the stream data,
the storage means transfers the stream data to the host means with reference to meta information stored in the storage means.

25. The storage device according to claim 14,
wherein the command processing unit receives a control command from the host means via the second interface unit.

26. The storage device according to claim 14,
wherein, when receiving the control command, the command processing unit transmits a response message indicating a ready state for the control command to the host means.
